(19) United States
(12) Patent Application Publication
(10) Pub. No.: US 2005/0244658 A1
(43) Pub. Date: Nov. 3, 2005

(54) Inorganic/organic hybrid oligomer and nano hybrid polymer for use in optical devices and displays, and process for preparing the same

(75) Inventors: Byeong-Soo Bae, Daejeon (KR); Young-Joo Eo, Daejeon (KR); Tae-Ho Lee, Daejeon (KR); Jung-Hwan Kim, Daejeon (KR)

Correspondence Address: STERNE, KESSLER, GOLDSTEIN & FOX PLLC, 1100 NEW YORK AVENUE, N.W., WASHINGTON, DC, 20005, US

(73) Assignee: Korea Advanced Institute of Science and Technology, Daejeon (KR)

(21) Appl. No.: 11/103,641

(22) Filed: Apr. 12, 2005

(30) Foreign Application Priority Data
Apr. 12, 2004 (KR) 10-2004-0025063

(51) Int. Cl. B32B 9/04; C08G 77/00

(52) U.S. Cl. 428/447; 528/29; 528/26

(57) ABSTRACT

The present invention provides an inorganic/organic hybrid oligomer having silica or a complex of silica and a metal oxide present inside thereof and functional organic groups outside thereof, obtained by reacting: (i) Compound 1 and Compound 2; (ii) Compound 1 and Compound 3; or (iii) Compound 2 and Compound 3 with Compound 1;
wherein Compound 1 is R¹R²Si(OH)₂, Compound 2 is (R³)ₐ(R⁴)_{b}M(OR⁵)_{(c-a-b)}, and Compound 3 is R⁶OH or R⁶COOH; a and b are each an integer between 0 and 3; c is an integer between 3 and 6; M is silicon, or a metal such as aluminum, titanium, zirconium, etc. that can be coordinated with ligands;
provided that in the cases of (i), (ii) and (iii) at least one of R¹, R², R³, R⁴ and R⁶ has a polymerizable functional group; an inorganic/organic nano hybrid polymer prepared therefrom and a process for preparing the same.

### BACKGROUND OF THE INVENTION

This application claims priority to Korean Patent Application No. 10-2004-0025063, filed Apr. 12, 2004, which is incorporated by reference herein in its entirety.

1. Field of the Invention

The present invention relates to inorganic/organic hybrid oligomers useful as raw materials for inorganic/organic nano hybrid polymers. The present invention is also directed to inorganic/organic nano hybrid polymers useful for fabricating optical devices, or dielectrics, barrier ribs or protective layers for plasma displays, and processes for preparing the same.

2. Description of the Related Art

Inorganic/organic nano hybrid polymers have been studied for application to a variety of optical devices and displays. These polymers not only have the transparency, abrasion resistance, heat resistance and insulating properties exhibited by inorganic materials, but also the flexibility, excellent coatability and functionalities exhibited by organic materials. Furthermore these polymers exhibit low temperature curing capability and excellent processability.

Conventional inorganic/organic nano hybrid polymers are prepared by a sol-gel method involving hydrolysis and condensation of organic metal alkoxide with water and a catalyst to prepare a solution, and then curing the solution. U.S. Pat. Nos. 6,054,253, 5,774,603 and 6,309,803 disclose methods for applying the inorganic/organic nano hybrid polymer prepared via the sol-gel method to optical devices. However, inorganic/organic nano hybrid polymers prepared with the above-mentioned sol-gel methods have poor curability at low temperatures, thus leaving silanol groups inside the material. These remaining silanol groups absorb the near infrared region wavelengths of 1310 nm and 1550 nm. These wavelengths are presently used in optical communications, thus causing a problem of high absorption loss. Additionally, upon prolonged use of the device of interest, silanol groups inside the material adsorb moisture in the atmosphere, resulting in deterioration of device performance. U.S. Pat. No. 6,391,515 proposes a process for preparing a silica based optical waveguide comprising preparing a solution using tetraethoxysilane by the sol-gel method, coating the solution over a silicon wafer and heat treating at 800° C. so as to effect sufficient curing, thus removing silanol groups. However, in the case of inorganic/organic nano hybrid polymers, high temperature curing cannot be applied because organic groups in the material are thermally degraded.

Korean Patent Application Nos. 2001-23552 and 2002-23553 disclose application of inorganic/organic nano hybrid polymer prepared by the sol-gel method as a gate insulator for a TFT-LCD, a protective layer of a color filter or a circuit protective layer. However, one disadvantage is the possibility of phase separation, thereby creating difficulty in realizing uniform characteristics of the material upon coating a large area, resulting from preparation of the inorganic/organic nano hybrid polymer by separately preparing and mixing an inorganic oxide sol, and an organic metal alkoxide in the form of polymer. Another disadvantage is the deterioration of transparency due to defects resulting from solvent evaporation upon drying because of using a large amount of a solvent. A further disadvantage is the poor dimensional stability and difficulty in obtaining a dense structure, thereby resulting in deterioration of voltage withstand or abrasion resistance.

### SUMMARY OF THE INVENTION

The present invention is directed to an inorganic/organic hybrid oligomer, wherein the oligomer is useful as a raw material for an inorganic/organic nano hybrid polymer used for fabricating optical devices, or dielectrics, barrier ribs and protective layers for plasma displays. The inorganic/organic nano hybrid polymers are useful because they have excellent optical characteristics, heat resistance, transparency, dielectric characteristics and abrasion resistance. The invention is also directed to a process for preparing the same.

The present invention also provides an inorganic/organic nano hybrid polymer and a process for preparing the same, using the above-mentioned inorganic/organic hybrid oligomer as raw material.

### DETAILED DESCRIPTION OF THE INVENTION

The present invention is directed to an inorganic/organic hybrid oligomer having a molecular weight of 100 to 10,000, and silica or a complex of silica and a metal oxide inside thereof and functional organic groups outside thereof, obtained by reacting:
(i) Compound 1 and Compound 2;
(ii) Compound 1 and Compound 3; or
(iii) Compound 2 and Compound 3 with Compound 1;
wherein Compound 1 is R¹R²Si(OH)₂, Compound 2 is (R³)ₐ(R⁴)_{b}M(OR⁵)_{(c-a-b)}, and Compound 3 is R⁶OH or R⁶COOH;
R¹, R², R³, and R⁴ are independently a linear, branched, or cyclic C₁-C₁₂ hydrocarbon or fluorocarbon wherein one or more carbons are replaced with one or more linkages selected from ester, ether, or amine linkages, and/or wherein the C₁-C₁₂ hydrocarbon or fluorocarbon is substituted with one or more alkyl, ketone, acryl, methacryl, allyl, aromatic, halogen, mercapto, alkoxy, sulfonyl, nitro, hydroxyl, cyclobutenyl, carbonyl, carboxyl, urethane, vinyl, cyano, hydrogen, or epoxy;
a and b are each an integer between 0 and 3;
c is an integer between 3 and 6;
M is silicon or a metal;
R⁵ is a linear, branched, or cyclic C₁-C₁₂ hydrocarbon substituted with one or more alkyl, alkoxy, ketone, or aromatic groups;

R⁶ is a linear, branched, or cyclic C₁-C₁₂ hydrocarbon or fluorocarbon wherein one or more carbons are replaced with one or more linkages selected from ester, ether, amide, imide, or amine linkages, and/or wherein the C₁-C₁₂ hydrocarbon or fluorocarbon is substituted with one or more alkyl, ketone, acryl, allyl, aromatic, halogen, cyano, mercapto, or epoxy;
provided that in the case of (i), at least one of R¹, R², R³, and R⁴ has a polymerizable functional group; in the case of (ii), at least one of R¹, R², and R⁶ has a polymerizable functional group; and in the case of (iii), at least one of R¹, R², R³, R⁴, and R⁶ has a polymerizable functional group.

In some embodiments, the present invention is directed to providing an inorganic/organic nano hybrid polymer obtained by thermal curing or photo-curing the inorganic/organic hybrid oligomer as described herein.

In some embodiments, the present invention provides an inorganic/organic nano hybrid polymer obtained by thermal curing or photo-curing the oligomer of the present invention and an additional organic monomer or oligomer having functional groups polymerizable with the functional organic groups of the above oligomer.

The present invention further provides a process for preparing an inorganic/organic hybrid oligomer having silica or a complex of silica and a metal oxide present inside thereof and functional organic groups present outside thereof, comprising reacting (i) Compound 1 and Compound 2, (ii) Compound 1 and Compound 3, or (iii) Compound 2 and Compound 3 with Compound 1, to obtain an oligomer;
wherein Compound 1 is R¹R²Si(OH)₂, Compound 2 is (R³)ₐ(R⁴)_{b}M(OR⁵)_{(c-a-b)}, and Compound 3 is R⁶OH or R⁶COOH;
R¹, R², R³, and R⁴ are independently a linear, branched, or cyclic C₁-C₁₂ hydrocarbon or fluorocarbon wherein one or more carbons are replaced with one or more linkages selected from ester, ether, or amine linkages, and/or wherein the C₁-C₁₂ hydrocarbon or fluorocarbon is substituted with one or more alkyl, ketone, acryl, methacryl, allyl, aromatic, halogen, mercapto, alkoxy, sulfonyl, nitro, hydroxyl, cyclobutenyl, carbonyl, carboxyl, urethane, vinyl, cyano, hydrogen, or epoxy;
a and b are each an integer between 0 and 3;
c is an integer between 3 and 6;
M is silicon or a metal;
R⁵ is a linear, branched, or cyclic C₁-C₁₂ hydrocarbon substituted with one or more alkyl, alkoxy, ketone, or aromatic groups;
R⁶ is a linear, branched, or cyclic C₁-C₁₂ hydrocarbon or fluorocarbon wherein one or more carbons are replaced with one or more linkages selected from ester, ether, amide, imide, or amine linkages, and/or wherein the C₁-C₁₂ hydrocarbon or fluorocarbon is substituted with one or more alkyl, ketone, acryl, allyl, aromatic, halogen, cyano, mercapto, or epoxy;
provided that in the case of (i), at least one of R¹, R², R³, and R⁴ has a polymerizable functional group; in the case of (ii), at least one of R¹, R², and R⁶ has a polymerizable functional group; and in the case of (iii), at least one of R¹, R², R³, R⁴, and R⁶ has a polymerizable functional group.

In some embodiments, the present invention provides a process for preparing an inorganic/organic nano hybrid polymer comprising reacting (i) Compound 1 and Compound 2, (ii) Compound 1 and Compound 3, or (iii) Compound 2 and Compound 3 with Compound 1, to prepare an oligomer having silica or a complex of silica and a metal oxide present inside thereof and functional organic groups present outside thereof; and thermal curing or photo-curing a multiplicity of the oligomers using the oligomer and the functional organic groups thereof to obtain an inorganic/organic nano hybrid polymer.

In some embodiments, the present invention provides a process for preparing an inorganic/organic nano hybrid polymer comprising reacting (i) Compound 1 and Compound 2, (ii) Compound 1 and Compound 3, or (iii) Compound 2 and Compound 3 with Compound 1, to prepare an oligomer having silica or a complex of silica and a metal oxide present inside thereof and functional organic groups present outside thereof; and thermal curing or photo-curing the oligomer and an additional organic monomer or oligomer having functional groups polymerizable with the functional organic groups of the above oligomer to obtain an inorganic/organic nano hybrid polymer.

In some embodiments, the process for preparing the inorganic/organic nano hybrid polymer of the present invention further comprises adding a metal oxide sol to reactants prior to a thermal curing or photo-curing.

In some embodiments, the aromatic is a heteroaromatic. In some embodiments, the epoxy is epoxycyclohexyl or glycidyloxy.

In some embodiments, M is silicon, or a metal. In some embodiments, the metal is aluminum, titanium, or zirconium, or any metal that can be coordinated with ligands.

“A complex of silica and metal oxide” as used herein refers to an internal bonding site wherein the organic functional groups (R¹, R², R³, and R⁴) of Compound 1 and Compound 2 are externally protruding as a result of reaction of silica having organic functional groups of Compound 1 with a metal oxide having organic functional groups of Compound 2.

“Inorganic/organic hybrid oligomer” as used herein refers to a compound in which inorganic components and organic components co-exist in the resulting material. “Inorganic/organic hybrid oligomer” in the present invention also refers to a compound of a core-shell structure having silica or a complex of silica and a metal oxide present inside thereof (a core layer), and functional organic groups present outside thereof (a shell layer). This core-shell structure can be formed by reacting (i) Compound 1 and Compound 2, (ii) Compound 1 and Compound 3, or (iii) Compound 2 and Compound 3 with Compound 1.

The term “polymerization” as used herein is intended to encompass any polymerization reactions including, but not limited to, radical polymerization, anionic polymerization, cationic polymerization, and condensational polymerization.

The term “inorganic/organic nano hybrid polymer” as used herein, refers to a polymer obtained by polymerizing the “inorganic/organic hybrid oligomer” as a basic unit, or polymerizing this inorganic/organic hybrid oligomer with an additional organic monomer or oligomer having a structure differing from those of Compounds 1 through 3.

A procedure for preparing an inorganic/organic hybrid oligomer by reacting Compound 1 and Compound 2 is shown in Reaction Scheme 1:

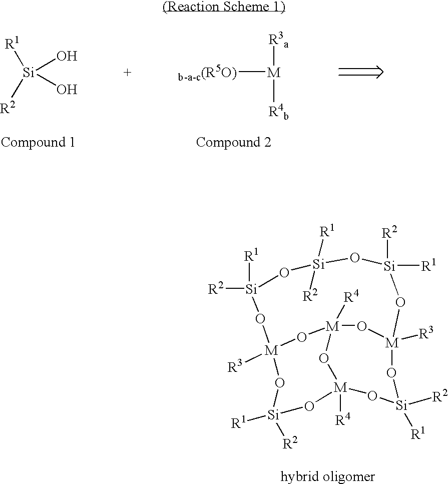

The oligomer obtained from Reaction Scheme 1 has a structure in which organic functional groups R¹, R², R³ and R⁴ constitute a shell layer, and a complex of silica and a metal oxide (SiMOₓ) forms an internal core.

Examples of specific materials encompassed by Compound 1 include diphenylsilanediol, diisobutylsilanediol and the like. All the compounds encompassed by Compound 1 can be used alone or in combinations thereof.

Examples of specific materials encompassed by Compound 2 include alkoxy silanes such as, but not limited to, 3-glycidoxypropyltrimethoxysilane, 3- glycidoxypropyltriethoxysilane, 3-glycidoxypropylmethyldimethoxysilane, 3-glycidoxypropylmethyldiethoxysilane, 3-glycidoxypropyltris(methoxyethoxy)silane, 2-(3,4-epoxycyclohexyl)ethyltrimethoxysilane, 2-(3,4-epoxycyclohexyl)ethyltriethoxysilane, 3-glycidoxypropylphenyldiethoxysilane, methyltrimethoxysilane, methyltriethoxysilane, methyltripropoxysilane, propylethyltrimethoxysilane, ethyltriethoxysilane, vinyltrimethoxysilane, vinyltriethoxysilane, vinyltripropoxysilane, dimethyldimethoxysilane, dimethyldiethoxysilane, vinylmethyldimethoxysilane, vinylmethyldiethoxysilane, phenyltrimethoxysilane, diphenylethoxyvinylsilane, tetramethoxysilane, tetraethoxysilane, tetrapropoxysilane, tetrabutoxysilane, tetraphenoxysilane, tetraacetoxysilane, N-(3-acryloxy-2-hydroxypropyl)-3-aminopropyltriethoxysilane, N-(3-acryloxy-2-hydroxypropyl)-3-aminopropyltrimethoxysilane, N-(3-acryloxy-2-hydroxypropyl)-3-aminopropyltripropoxysilane, 3-acryloxypropyldimethylmethoxysilane, 3-acryloxypropyldimethylethoxysilane, 3-acryloxypropyldimethylpropoxysilane, 3-acryloxypropylmethylbis(trimethylsiloxy)silane, 3-acryloxypropyltrimethoxysilane, 3-acryloxypropyltriethoxysilane, 3-acryloxypropyltripropoxysilane, 3-(meth)acryloxypropyltrimethoxysilane, 3-(meth)acryloxypropyltriethoxysilane, 3-(meth)acryloxypropyltripropoxysilane, N-(2-aminoethyl-3-aminopropyl)trimethoxysilane, N-(2-aminoethyl-3-aminopropyl)triethoxysilane, 3-aminopropyltrimethoxysilane, 3-aminopropyltriethoxysilane, chloropropyltrimethoxysilane, chloropropyltriethoxysilane, trimethoxysilylpropyldiethylenetriamine and heptadecafluordecyltrimethoxysilane; metal alkoxides such as, but not limited to, aluminium triethoxide, aluminium tripropoxide, aluminium tributoxide, titanium tetraethoxide, titanium tetrapropoxide, titanium tetrabutoxide, zirconium tetraethoxide, zirconium tetrapropoxide, zirconium tetrabutoxide, tin tetraethoxide, tin tetrapropoxide and tin tetrabutoxide; or complex compounds between a metal alkoxide and -diketone or -ketoester.

Alkoxysilanes, metal alkoxides or complexes thereof encompassed by Compound 2, can be used alone or in combinations thereof.

A procedure for preparing an inorganic/organic hybrid oligomer by reacting Compound 1 and Compound 3 is shown in Reaction Scheme 2:

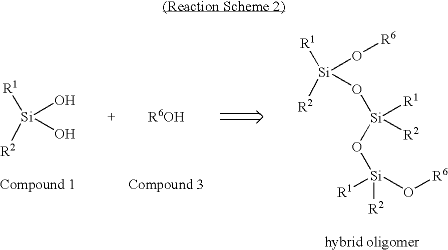

The oligomer obtained from the above Reaction Scheme 2 has a structure in which organic functional groups R¹, R², and R⁶ constitute a shell layer, and silica (SiOₓ) forms an internal core.

Examples of specific materials represented by Compound 3 include, but are not limited to, hydroxy acrylate monomers or oligomers or co-oligomers thereof, such as, but not limited to, 2-hydroxyethyl acrylate, 2-hydroxypropyl acrylate, 2-hydroxyethyl methacrylate, 2-hydroxypropyl methacrylate, 3-hydroxypropyl acrylate, 3-hydroxy propyl methacrylate and hydroxyallyl methacrylate; diols or oligomers or co-oligomers thereof, such as, but not limited to, polyester polyol, polyether polyol, polycarbonate polyol, polycarprolactone polyol, ring-opened tetrahydrofuran propylene oxide copolymer, polybutadienediol, ethyleneglycol, propyleneglycol, 1,4-butanediol, 1,5-pentanediol, 1,6-hexanediol, neopentylglycol, 1,4-cyclohexanedimethanol, bisphenol A and hydrogenated bisphenol A; and

monomers of carboxylic acids or oligomers or co-oligomers thereof, such as, but not limited to, acrylic acid, methacrylic acid, polyacrylic acid, polymethacrylic acid and polyamic acid. Each material encompassed by Compound 3 can be used alone or in combinations thereof.

In some embodiments, reacting Compound 2 and Compound 3 with Compound 1 can prepare an inorganic/organic hybrid oligomer of the present invention.

In some embodiments, a catalyst is added in order to promote the reactions in Reaction Schemes 1 and 2. In some embodiments, usable catalysts include, but are not limited to, acidic catalysts such as acetic acid, phosphoric acid, sulfuric acid, hydrochloric acid, nitric acid, chlorosulfonic acid, para-toluic acid, trichloroacetic acid, polyphosphoric acid, pyrophosphoric acid, hydroiodic acid, stannic acid and perchloric acid, and basic catalysts such as, but not limited to, ammonia, sodium hydroxide, n-butylamine, di-n-butylamine, tri-n-butylamine, imidazole, ammonium perchlorate, potassium hydroxide and barium hydroxide. Various amounts of catalyst can be added. In some embodiments, 0.0001 to 1 part by weight of the catalyst based on the total amount of the reactants can be added. The reactions in Reaction Schemes 1 and 2 can be conducted by stirring at a temperature of 70° C. to 90° C. for 4 to 8 hours.

The inorganic/organic nano hybrid polymer can be obtained by polymerizing the inorganic/organic hybrid oligomer obtained from Reaction Schemes 1 and 2 as a basic unit, or polymerizing this inorganic/organic hybrid oligomer with a third organic monomer or oligomer having a structure differing from those of Compounds 1 through 3. These processes are shown in Reaction Schemes 3 and 4.

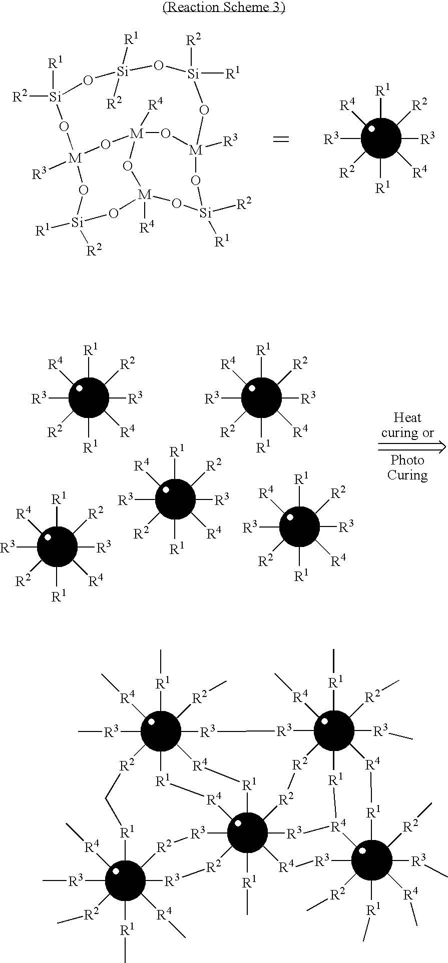

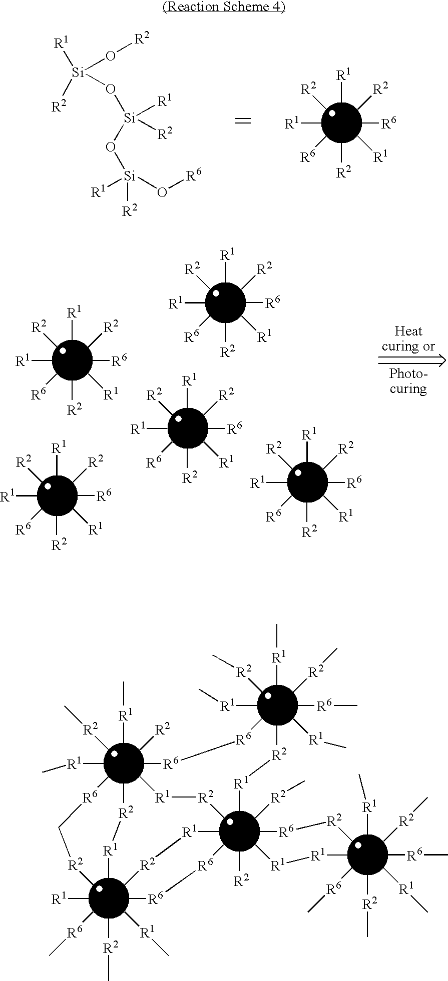

In Reaction Schemes 3 and 4, polymerization can be performed by thermal curing or photo-curing reactions between organic functional groups constituting shell layers of the respective oligomers.

The additional organic monomer having a structure differing from those of Compounds 1 through 3 can include any organic compound having functional groups polymerizable with the functional groups of one or more of Compounds 1 through 3. For example, in some embodiments, the third functional group can be a linear, branched, or cyclic C₁-C₃₀ hydrocarbon or fluorocarbon-based group wherein one or more carbons are replaced with one or more linkages selected from amine, ether, or ester, and/or wherein the C₁-C₃₀ hydrocarbon or fluorocarbon-based group is substituted with one or more alkyl, ketone, acryl, methacryl, allyl, aromatic, halogen, mercapto, alkoxy, sulfonyl, nitro, hydroxyl, cyclobutenyl, carbonyl, carboxyl, urethane, vinyl, cyano, hydrogen, or epoxy.

In some embodiments, the oligomer has a molecular weight of less than 10,000. In some embodiments, the oligomer can be, but is not limited to, (meth)acrylic acid, (meth)acrylate, bisphenol A, pyromellitic dianhydride, polycarbonate polyol, polyester polyol, urethane(meth)acrylate, epoxy(meth)acrylate, polyolefin epoxy resin, bisphenol A-type epoxy resin, dianhydride type resin and polyamic acid.

For photo-curing reaction, initiators such as 1-hydroxy-2-methyl-1-phenylpropan-1-one (Darocure® 1173, Ciba Specialty Chemicals, Switzerland), 2-methyl-1-[(4-(methylthiophenyl)-morpholinopropanone) (Darocure® 907, Ciba Specialty Chemicals, Switzerland), 1-hydroxy cyclohexyl phenyl ketone (Irgacure(® 184, Ciba Specialty Chemicals, Switzerland), benzoin, benzoin methyl ether, benzoin isopropyl ether, benzoin butyl ether, benzyl, benzophenone, 2-hydroxy-2-methyl propiophenone, 2,2-diethoxy acetophenone, 2-chlorothioxantone, anthracene or 3,3,4,4-tetra-(t-butylperoxy carbonyl)benzophenone, 2,2-dimethoxy-2-phenyl-acetophenone and 2-benzyl-2-dimethylamino-4-morpholinobutyrophenone (Irgacure® 369, Ciba Specialty Chemicals, Switzerland) can be used, but are not limited to those. For thermal curing reaction, 2,5-bis-(tert-butyl-peroxy)-2,5-dimethylhexane, tert-butylperoxy-2-ethyl-hexanoate, benzoyl peroxide, methyl ethyl ketone peroxide, 2,2-azo-bis-isobutyronitrile or 2,2-azo-bis-(2,4-dimethylvaleronitrile), t-butyl peroxy benzoate and 1-methylimidazole can be used, but are not limited to those. Various amounts of the initiator can be added. In some embodiments, 0.01 to 10 parts by weight of the initiator based on the total amount of the reactants are added. If below 0.01 parts by weight is used, polymerization does not effectively progress, causing difficulty in realizing desired performance. If above 10 parts by weight is used, there is no deterioration of characteristics, but it is disadvantageous from an economic point of view.

In the present invention, in order to impart additional performance, the process can further comprise adding an appropriate amount of a dye, pigment, and/or surfactant to control transparency and applicability during an intermediate step of preparing the inorganic/organic nano hybrid polymer.

The inorganic/organic hybrid oligomer or the inorganic/organic nano hybrid polymer of the present invention can be usefully employed in fabricating optical devices. Additionally, the present invention can be usefully employed in displays having a dielectric, insulator, barrier rib, or protective layer including the inorganic/organic hybrid oligomer or the inorganic/organic nano hybrid polymer.

Now, the present invention will be described in more detail with reference to the following Examples. These examples are provided only for illustrating the present invention and should not be construed as limiting the scope and sprit of the present invention.

### EXAMPLES

### Example 1

### Preparation of methacryl-phenyl-silica nano hybrid polymer

13.78 g of 3-methacryloxypropyltrimethoxysilane (Sigma-Aldrich, St. Louis, Mo.) and 12.00 g of diphenylsilanediol (Fluka, Switzerland) were mixed, and then as a catalyst to promote a siloxane reaction, 0.1 g of sodium hydroxide was added thereto. The mixture was stirred at a temperature of 80° C. for 6 hours to obtain a methacryl-phenyl-silica oligomer.

To the methacryl-phenyl-silica oligomer thus obtained was added 0.25 g of 2,2-dimethoxy-2-phenyl-acetophenone (Sigma-Aldrich, St. Louis, Mo.) as a photo initiator for acrylic curing. Thereafter, it was coated on a substrate as described in Examples 21-25 and 3 J/cm² of UV light was irradiated on the coating using a 365 nm UV lamp and cured at a temperature of 150° C. for 4 hours to prepare a methacryl-phenyl-silica nano hybrid polymer.

### Example 2

### Preparation of epoxy-phenyl-silica nano hybrid polymer

13.78 g of 3-glycidoxypropyltrimethoxysilane (Sigma-Aldrich, St. Louis, Mo.) and 12.00 g of diphenylsilanediol (Fluka, Switzerland) were mixed, and then as a catalyst to promote a siloxane reaction, 0.1 g of sodium hydroxide was added thereto. The mixture was stirred at a temperature of 80° C. for 6 hours to obtain an epoxy-phenyl-silica oligomer.

To the epoxy-phenyl-silica oligomer thus obtained was added 0.25 g of 1-methylimidazole (Sigma-Aldrich, St. Louis, Mo.) as a thermal initiator for epoxy curing. Thereafter, it was coated on a substrate as described in the following Examples 21-25 and was cured at a temperature of 130° C. for 2 hours to prepare an epoxy-phenyl-silica nano hybrid polymer.

### Example 3

### Preparation of methacryl-isobutyl-silica nano hybrid polymer

13.11 g of 3-methacryloxypropyltrimethoxysilane (Sigma-Aldrich, St. Louis, Mo.) and 10.05 g of diisobutylsilanediol, prepared according to the method described in Mutahi et al., J. Am. Chem. Soc. 124: 7363 (2002), were mixed, and then as a catalyst to promote a siloxane reaction, 0.1 g of sodium hydroxide was added thereto. The mixture was stirred at a temperature of 80° C. for 6 hours to obtain a methacryl-isobutyl-silica oligomer.

To the methacryl-isobutyl-silica oligomer thus obtained was added 0.25 g of 2,2-dimethoxy-2-phenyl-acetophenone (Sigma-Aldrich, St. Louis, Mo.) as a photo initiator for acrylic curing. Thereafter, it was coated on a substrate as described in the following Examples 21-25 and 3 J/cm² of UV light was irradiated on the coating using a 365 nm UV lamp and cured at a temperature of 150° C. for 4 hours to prepare a methacryl-isobutyl-silica nano hybrid polymer.

### Example 4

### Preparation of epoxy-isobutyl-silica nano hybrid polymer

13.11 g of 3-glycidoxypropyltrimethoxysilane (Sigma-Aldrich, St. Louis, Mo.) and 10.05 g of diisobutylsilanediol, prepared according to the method described in Mutahi et al., J. Am. Chem. Soc. 124: 7363 (2002), were mixed, and then as a catalyst to promote a siloxane reaction, 0.1 g of sodium hydroxide was added thereto. The mixture was stirred at a temperature of 80° C. for 6 hours to obtain an epoxy-isobutyl-silica oligomer.

To the epoxy-isobutyl-silica oligomer thus obtained was added 0.25 g of 1-methylimidazole (Sigma-Aldrich, St. Louis, Mo.) as a thermal initiator for epoxy curing. Thereafter, it was coated on a substrate as described in the following Examples 21-25 and cured at a temperature of 130° C. for 2 hours to prepare an epoxy-isobutyl-silica nano hybrid polymer.

### Example 5

### Preparation of epoxy-methacryl-phenyl-silica nano hybrid polymer

5.78 g of 3-glycidoxypropyltrimethoxysilane (Sigma-Aldrich, St. Louis, Mo.), 7.87 g of 3-methacryloxypropyltrimethoxysilane (Sigma-Aldrich, St. Louis, Mo.) and 12.00 g of diphenylsilanediol were mixed, and then as a catalyst to promote a siloxane reaction, 0.1 g of sodium hydroxide was added thereto. The mixture was stirred at a temperature of 80° C. for 6 hours to obtain an epoxy-methacryl-phenyl-silica oligomer.

To the epoxy-methacryl-phenyl-silica oligomer thus obtained was added 1.36 g of bisphenol A (Sigma-Aldrich, St. Louis, Mo.) dissolved in 20 g of toluene followed by 0.25 g of 1-methylimidazole (Sigma-Aldrich, St. Louis, Mo.) as a thermal initiator for epoxy curing. Thereafter, it was coated on a substrate as described in the following Examples 21-25 and cured at a temperature of 130° C. for 2 hours to prepare an epoxy-methacryl-phenyl-silica nano hybrid polymer.

### Example 6

### Preparation of methacryl-phenyl-silica-zirconia nano hybrid polymer

A methacryl-phenyl-silica-zirconia nano hybrid polymer was prepared by performing the same procedure as in Example 1 except that 10.33 g of 3-methacryloxypropyltrimethoxysilane (Sigma-Aldrich, St. Louis, Mo.) and 3.45 g of zirconium tetraisopropoxide were used instead of 13.78 g of 3-methacryloxypropyltrimethoxysilane (Sigma-Aldrich, St. Louis, Mo.).

### Example 7

### Preparation of epoxy-phenyl-silica-zirconia nano hybrid polymer

An epoxy-phenyl-silica-zirconia nano hybrid polymer was prepared by performing the same procedure as in Example 2 except that 10.33 g of 3-glycidoxypropyltrimethoxysilane (Sigma-Aldrich, St. Louis, Mo.) and 3.45 g of zirconium tetraisopropoxide were used instead of 13.78 g of 3-glycidoxypropyltrimethoxysilane (Sigma-Aldrich, St. Louis, Mo.).

### Example 8

### Preparation of methacryl-isobutyl-silica-titania nano hybrid polymer

A methacryl-isobutyl-silica titania nano hybrid polymer was prepared by performing the same procedure as in Example 3 except that 9.83 g of 3-methacryloxypropyltrimethoxysilane (Sigma-Aldrich, St. Louis, Mo.) and 3.28 g of titanium tetraethoxide were used instead of 13.11 g of 3-methacryloxypropyltrimethoxysilane (Sigma-Aldrich, St. Louis, Mo.).

### Example 9

### Preparation of epoxy-isobutyl-silica-titania nano hybrid polymer

An epoxy-isobutyl-silica-titania nano hybrid polymer was prepared by performing the same procedure as in Example 4 except that 9.83 g of 3-glycidoxypropyltrimethoxysilane (Sigma-Aldrich, St. Louis, Mo.) and 3.28 g of titanium tetraethoxide were used instead of 13.11 g of 3-glycidoxypropyltrimethoxysilane (Sigma-Aldrich, St. Louis, Mo.).

### Example 10

### Preparation of epoxy-methacryl-phenyl-silica-titania-zirconia nano hybrid polymer

An epoxy-methacryl-phenyl-silica-titania-zirconia nano hybrid polymer was prepared by performing the same procedure as in Example 5 except that 4.28 g of 3-glycidoxypropyltrimethoxysilane (Sigma-Aldrich, St. Louis, Mo.), 1.5 g of zirconium tetraisopropoxide, 5.9 g of 3-methacryloxypropyltrimethoxysilane (Sigma-Aldrich, St. Louis, Mo.) and 1.97 g of titanium tetraethoxide were used instead of 5.78 g of 3-glycidoxypropyltrimethoxysilane (Sigma-Aldrich, St. Louis, Mo.) and 7.87 g of 3-methacryloxypropyltrimethoxysilane (Sigma-Aldrich, St. Louis, Mo.).

### Example 11

### Preparation of epoxy-methacryl-phenyl-silica nano hybrid polymer

An epoxy-methacryl-phenyl-silica nano hybrid polymer was prepared by performing the same procedure as in Example 5 except that 1.95 g of methacrylic acid, 2.3 g of 3-methacryloxypropyltrimethoxysilane (Sigma-Aldrich, St. Louis, Mo.) and 7.87 g of 3-glycidoxypropyltrimethoxysilane (Sigma-Aldrich, St. Louis, Mo.) were used instead of 5.78 g of 3-glycidoxypropyltrimethoxysilane (Sigma-Aldrich, St. Louis, Mo.) and 7.87 g of 3-methacryloxypropyltrimethoxysilane (Sigma-Aldrich, St. Louis, Mo.).

### Example 12

### Preparation of epoxy-methacryl-phenyl-silica-titania-zirconia nano hybrid polymer

An epoxy-methacryl-phenyl-silica-titania-zirconia nano hybrid polymer was prepared by performing the same procedure as in Example 5 except that 4.28 g of 3-glycidoxypropyltrimethoxysilane (Sigma-Aldrich, St. Louis, Mo.), 1.5 g of zirconium tetraisopropoxide, 0.95 g of methacrylic acid, 3.3 g of 3-methacryloxypropyltrimethoxysilane (Sigma-Aldrich, St. Louis, Mo.) and 1.97 g of titanium tetraethoxide were used instead of 5.78 g of 3-glycidoxypropyltrimethoxysilane (Sigma-Aldrich, St. Louis, Mo.) and 7.87 g of 3-methacryloxypropyltrimethoxysilane (Sigma-Aldrich, St. Louis, Mo.).

### Example 13

### Preparation of methacryl-phenyl-silica nano hybrid polymer

A methacryl-phenyl-silica nano hybrid polymer was prepared by performing the same procedure as in Example 1 except that 13.56 g of diphenyldimethoxysilane (Fluka, Switzerland) and 2 g of water for hydrolysis and condensation were used instead of diphenylsilanediol.

### Example 14

### Preparation of epoxy-phenyl-silica nano hybrid polymer

An epoxy-phenyl-silica nano hybrid polymer was prepared by performing the same procedure as in Example 2 except that 13.56 g of diphenyldimethoxysilane (Fluka, Switzerland) and 2 g of water for hydrolysis and condensation were used instead of diphenylsilanediol.

### Example 15

### Preparation of epoxy-methacryl-phenyl-silica nano hybrid polymer

An epoxy-methacryl-phenyl-silica nano hybrid polymer was prepared by performing the same procedure as in Example 5 except that 13.56 g of diphenyldimethoxysilane (Fluka, Switzerland) and 2 g of water for hydrolysis and condensation were used instead of diphenylsilanediol.

### Example 16

### Preparation of methacryl-phenyl-silica-zirconia nano hybrid polymer

A methacryl-phenyl-silica-zirconia nano hybrid polymer was prepared by performing the same procedure as in Example 6 except that 13.56 g of diphenyldimethoxysilane (Fluka, Switzerland) and 2 g of water for hydrolysis and condensation were used instead of diphenylsilanediol.

### Example 17

### Preparation of epoxy-phenyl-silica-zirconia nano hybrid polymer

An epoxy-phenyl-silica-zirconia nano hybrid polymer was prepared by performing the same procedure as in Example 7 except that 13.56 g of diphenyldimethoxysilane (Fluka, Switzerland) and 2 g of water for hydrolysis and condensation were used instead of diphenylsilanediol.

### Example 18

### Preparation of epoxy-methacryl-phenyl-silica-titania-zirconia nano hybrid polymer

An epoxy-methacryl-phenyl-silica-titania-zirconia nano hybrid polymer was prepared by performing the same procedure as in Example 10 except that 13.56 g of diphenyldimethoxysilane (Fluka, Switzerland) and 2 g of water for hydrolysis and condensation were used instead of diphenylsilanediol.

### Example 19

### Preparation of epoxy-methacryl-phenyl-silica-titania-zirconia nano hybrid polymer

An epoxy-methacryl-phenyl-silica-titania-zirconia nano hybrid polymer was prepared by performing the same procedure as in Example 11 except that 13.56 g of diphenyldimethoxysilane (Fluka, Switzerland) and 2 g of water for hydrolysis and condensation were used instead of diphenylsilanediol.

### Example 20

### Preparation of epoxy-methacryl-phenyl-silica-titania-zirconia nano hybrid polymer

An epoxy-methacryl-phenyl-silica-titania-zirconia nano hybrid polymer was prepared by performing the same procedure as in Example 12 except that 13.56 g of diphenyldimethoxysilane (Fluka, Switzerland) and 2 g of water for hydrolysis and condensation were used instead of diphenylsilanediol.

### Example 21

### Analysis of absorbance characteristics in near-infrared region

Materials mentioned in Examples 1 through 20 were applied and coated to a thickness of 30 μm, on a quartz substrate and cured followed by measurement of absorbance at 1310 mm and 1550 nm. The results are shown in Table 1 in terms of dB/cm.

### Example 22

### Heat Resistance

Materials mentioned in Examples 1 through 20 were cured and thereafter the temperature was measured with respect to changes of 5% in weight at an elevation rate of 5° C./min under nitrogen atmosphere. The results are shown in Table 1.

### Example 23

### Transparency

Materials mentioned in Examples 1 through 20 were applied to a thickness of 10 μm, on a quartz substrate and transmittance was measured at 400 nm. The results are shown in Table 1.

### Example 24

### Dielectric Strength

Materials mentioned in Examples 1 through 20 were applied to a thickness of 30 μm, on an ITO-deposited quartz substrate and DC voltage was applied thereto to measure the voltage at which dielectric breakdown initiated. The results are shown in Table 1.

### Example 25

### Abrasion Resistance

Materials mentioned in Examples 1 through 20 were coated and cured to a thickness of 20 μm, on a glass substrate and pencil hardness was measured. The results are shown in Table 1.

TABLE 1

| | Absorbance | | Heat | | Dielectric | Abrasion |
|---|---|---|---|---|---|---|
| | 1310 nm | 1550 nm | Resistance | Transparency | Strength | Resistance |
| Ex. 1 | 0.4 dB/cm | 0.7 dB/cm | 310° C. | 96% | 8.0 kv | 6H |
| Ex. 2 | 0.3 dB/cm | 0.6 dB/cm | 360° C. | 96% | 8.4 kv | 6H |
| Ex. 3 | 0.5 dB/cm | 0.8 dB/cm | 390° C. | 95% | 7.8 kv | 6H |
| Ex. 4 | 0.4 dB/cm | 0.7 dB/cm | 410° C. | 95% | 7.6 kv | 6H |
| Ex. 5 | 0.4 dB/cm | 0.8 dB/cm | 330° C. | 95% | 8.1 kv | 7H |
| Ex. 6 | 0.2 dB/cm | 0.5 dB/cm | 340° C. | 93% | 8.4 kv | 7H |
| Ex. 7 | 0.2 dB/cm | 0.4 dB/cm | 380° C. | 94% | 8.8 kv | 8H |
| Ex. 8 | 0.3 dB/cm | 0.6 dB/cm | 400° C. | 93% | 8.3 kv | 7H |
| Ex. 9 | 0.2 dB/cm | 0.5 dB/cm | 410° C. | 94% | 8.2 kv | 8H |
| Ex. 10 | 0.6 dB/cm | 0.9 dB/cm | 420° C. | 94% | 8.2 kv | 7H |
| Ex. 11 | 0.4 dB/cm | 0.7 dB/cm | 370° C. | 94% | 8.5 kv | 8H |
| Ex. 12 | 0.4 dB/cm | 0.8 dB/cm | 380° C. | 94% | 8.6 kv | 7H |
| Ex. 13 | 2.5 dB/cm | 3.3 dB/cm | 300° C. | 88% | 4.3 kv | 4H |
| Ex. 14 | 2.4 dB/cm | 3.1 dB/cm | 330° C. | 87% | 4.6 kv | 5H |
| Ex. 15 | 2.5 dB/cm | 3.6 dB/cm | 310° C. | 85% | 4.4 kv | 4H |
| Ex. 16 | 2.1 dB/cm | 2.9 dB/cm | 310° C. | 83% | 4.2 kv | 5H |
| Ex. 17 | 1.9 dB/cm | 2.7 dB/cm | 340° C. | 88% | 4.2 kv | 5H |
| Ex. 18 | 1.8 dB/cm | 2.8 dB/cm | 380° C. | 88% | 4.3 kv | 5H |
| Ex. 19 | 2.8 dB/cm | 3.4 dB/cm | 340° C. | 85% | 4.4 kv | 5H |
| Ex. 20 | 1.9 dB/cm | 2.6 dB/cm | 350° C. | 84% | 4.7 kv | 5H |

Table 1 demonstrates that the inorganic/organic nano hybrid polymers of the present invention have excellent optical characteristics, heat resistance, dielectric characteristics, transparency and abrasion resistance, as compared to conventional inorganic/organic nano hybrid polymers prepared by the sol-gel method, and thus can realize better performance upon application to optical devices and displays.

The inorganic/organic nano hybrid polymer prepared in accordance with the present invention exhibits excellent optical characteristics, heat, transparency, dielectric characteristics and abrasion resistance by improving disadvantages and problems exhibited in the conventional inorganic/organic nano hybrid polymeric material prepared with the conventional sol-gel method. Thus, the inorganic/organic nano hybrid polymer prepared in accordance with the present invention can be usefully employed in fabricating optical devices, or dielectrics, barrier ribs and protective layers for displays.

These examples illustrate several possible compositions, methods and processes of the present invention. While the invention has been particularly shown and described with reference to some embodiments thereof, it will be understood by those skilled in the art that they have been presented by way of example only, and not limitation, and various changes in form and details can be made therein without departing from the spirit and scope of the invention. Thus, the breadth and scope of the present invention should not be limited by any of the above-described exemplary embodiments, but should be defined only in accordance with the following claims and their equivalents.

All documents cited herein, including journal articles or abstracts, published or corresponding U.S. or foreign patent applications, issued or foreign patents, or any other documents, are each entirely incorporated by reference herein, including all data, tables, figures, and text presented in the cited documents.

1. An inorganic/organic hybrid oligomer having silica or a complex of silica and a metal oxide present inside thereof and functional organic groups outside thereof, obtained by reacting:
(i) Compound 1 and Compound 2;
(ii) Compound 1 and Compound 3; or
(iii) Compound 2 and Compound 3 with Compound 1;
wherein Compound 1 is R¹R²Si(OH)₂, Compound 2 is (R³)ₐ(R⁴)_{b}M(OR⁵)_{(c-a-b)}, and Compound 3 is R⁶OH or R⁶COOH;
R¹, R², R³, and R⁴ are independently a linear, branched, or cyclic C₁-C₁₂ hydrocarbon or fluorocarbon wherein one or more carbons are replaced with one or more linkages selected from ester, ether, or amine linkages, and/or wherein the C₁-C₁₂ hydrocarbon or fluorocarbon is substituted with one or more alkyl, ketone, acryl, methacryl, allyl, aromatic, halogen, mercapto, alkoxy, sulfonyl, nitro, hydroxyl, cyclobutenyl, carbonyl, carboxyl, urethane, vinyl, cyano, hydrogen, or epoxy;
a and b are independently each an integer between 0 and 3;
c is an integer between 3 and 6;
M is silicon or a metal;
R⁵ is a linear, branched, or cyclic C₁-C₁₂ hydrocarbon substituted with one or more alkyl, alkoxy, ketone, or aromatic groups;
R⁶ is a linear, branched, or cyclic C₁-C₁₂ hydrocarbon or fluorocarbon wherein one or more carbons are replaced with one or more linkages selected from ester, ether, amide, imide, or amine linkages, and/or wherein the C₁-C₁₂ hydrocarbon or fluorocarbon is substituted with one or more alkyl, ketone, acryl, allyl, aromatic, halogen, cyano, mercapto, or epoxy;
provided that in the case of (i), at least one of R¹, R², R³, and R⁴ has a polymerizable functional group; in the case of (ii), at least one of R¹, R², and R⁶ has a polymerizable functional group; and in the case of (iii), at least one of R¹, R², R³, R⁴, and R⁶ has a polymerizable functional group.

2. The oligomer of claim 1, wherein Compound 1 is diphenylsilanediol or diisobutylsilanediol.

3. The oligomer of claim 1, wherein Compound 2 is an alkoxy silane selected from the group consisting of 3-glycidoxypropyltrimethoxysilane, 3-glycidoxypropyltriethoxysilane, 3-glycidoxypropylmethyldimethoxysilane, 3-glycidoxypropylmethyldiethoxysilane, 3-glycidoxypropyltris(methoxyethoxy)silane, 2-(3,4-epoxycyclohexyl)ethyltrimethoxysilane, 2-(3,4-epoxycyclohexyl)ethyltriethoxysilane, 3-glycidoxypropylphenyldiethoxysilane, methyltrimethoxysilane, methyltriethoxysilane, methyltripropoxysilane, propylethyltrimethoxysilane, ethyltriethoxysilane, vinyltrimethoxysilane, vinyltriethoxysilane, vinyltripropoxysilane, dimethyldimethoxysilane, dimethyldiethoxysilane, vinylmethyldimethoxysilane, vinylmethyldiethoxysilane, phenyltrimethoxysilane, diphenylethoxyvinylsilane, tetramethoxysilane, tetraethoxysilane, tetrapropoxysilane, tetrabutoxysilane, tetraphenoxysilane, tetraacetoxysilane, N-(3-acryloxy-2-hydroxypropyl)-3-aminopropyltriethoxysilane, N-(3-acryloxy-2-hydroxypropyl)-3-aminopropyltrimethoxysilane, N-(3-acryloxy-2-hydroxypropyl)-3-aminopropyltripropoxysilane, 3-acryloxypropyldimethylmethoxysilane, 3-acryloxypropyldimethylethoxysilane, 3-acryloxypropyldimethylpropoxysilane, 3-acryloxypropylmethylbis(trimethylsiloxy)silane, 3-acryloxypropyltrimethoxysilane, 3-acryloxypropyltriethoxysilane, 3-acryloxypropyltripropoxysilane, 3-(meth)acryloxypropyltrimethoxysilane, 3-(meth)acryloxypropyltriethoxysilane, 3-(meth)acryloxypropyltripropoxysilane, N-(2-aminoethyl-3-aminopropyl)trimethoxysilane, N-(2-aminoethyl-3-aminopropyl)triethoxysilane, 3-aminopropyltrimethoxysilane, 3-aminopropyltriethoxysilane, chloropropyltrimethoxysilane, chloropropyltriethoxysilane, trimethoxysilylpropyldiethylenetriamine and heptadecafluorodecyltrimethoxysilane; metal alkoxides selected from the group consisting of aluminium triethoxide, aluminium tripropoxide, aluminium tributoxide, titanium tetraethoxide, titanium tetrapropoxide, titanium tetrabutoxide, zirconium tetraethoxide, zirconium tetrapropoxide, zirconium tetrabutoxide, tin tetraethoxide, tin tetrapropoxide and tin tetrabutoxide; complex compounds between a metal alkoxide and -diketone or -ketoester; and combinations thereof.

4. The oligomer of claim 1, wherein Compound 3 is a hydroxy acrylate monomer or oligomers or co-oligomers thereof selected from the group consisting of 2-hydroxyethyl acrylate, 2-hydroxypropyl acrylate, 2-hydroxyethyl methacrylate, 2-hydroxypropyl methacrylate, 3-hydroxypropyl acrylate, 3-hydroxypropyl methacrylate and hydroxyallyl methacrylate; diols or oligomers or co-oligomers thereof, selected from the group consisting of polyester polyol, polyether polyol, polycarbonate polyol, polycarprolactone polyol, ring-opened tetrahydrofuran propyleneoxide copolymer, polybutadienediol, ethyleneglycol, propyleneglycol, 1,4-butanediol, 1,5-pentanediol, 1,6-hexanediol, neopentylglycol, 1,4-cyclohexanedimethanol, bisphenol A and hydrogenated bisphenol A; monomers of carboxylic acids or oligomers or co-oligomers thereof selected from the group consisting of acrylic acid, methacrylic acid, polyacrylic acid, polymethacrylic acid, and polyamic acid; and combinations thereof.

5. An inorganic/organic nano hybrid polymer obtained by thermal curing or photo-curing the inorganic/organic hybrid oligomer of claim 1.

6. An inorganic/organic nano hybrid polymer obtained by thermal curing or photo-curing the oligomer of claim 1 and an additional organic monomer or oligomer having functional groups polymerizable with the functional organic groups of the oligomer.

7. A process for preparing an inorganic/organic hybrid oligomer having silica or a complex of silica and a metal oxide present inside thereof and functional organic groups present outside thereof, comprising reacting:
(i) Compound 1 and Compound 2;
(ii) Compound 1 and Compound 3; or
(iii) Compound 2 and Compound 3 with Compound 1;
to obtain an oligomer wherein Compound 1 is R¹R²Si(OH)₂, Compound 2 is (R³)ₐ(R⁴)_{b}M(OR⁵)_{(c-a-b)}, and Compound 3 is R⁶OH or R⁶COOH;
R¹, R², R³, and R⁴ are independently a linear, branched, or cyclic C₁-C₁₂ hydrocarbon or fluorocarbon wherein one or more carbon are replaced with one or more linkages selected from ester, ether, or amine linkages, and/or wherein the C₁-C₁₂ hydrocarbon or fluorocarbon is substituted with one or more alkyl, ketone, acryl, methacryl, allyl, aromatic, halogen, mercapto, alkoxy, sulfonyl, nitro, hydroxyl, cyclobutenyl, carbonyl, carboxyl, urethane, vinyl, cyano, hydrogen, or epoxy;
a and b are independently each an integer between 0 and 3;
c is an integer between 3 and 6;
M is silicon or a metal;
R⁵ is a linear, branched, or cyclic C₁-C₁₂ hydrocarbon substituted with one or more alkyl, alkoxy, ketone, or, aromatic groups;
R⁶ is a linear, branched, or cyclic C₁-C₁₂ hydrocarbon or fluorocarbon wherein one or more carbons is substituted one or more linkages selected from ester, ether, amide, imide, or amine linkages, and/or wherein the C₁-C₁₂ hydrocarbon or fluorocarbon is substituted with one or more alkyl, ketone, acryl, allyl, aromatic, halogen, cyano, mercapto, or epoxy;
provided that in the case of (i), at least one of R¹, R², R³, and R⁴ has a polymerizable functional group; in the case of (ii), at least one of R¹, R², and R⁶ has a polymerizable functional group; and in the case of (iii), at least one of R¹, R², R³, R⁴, and R⁶ has a polymerizable functional group.

8. A process for preparing an inorganic/organic nano hybrid polymer, comprising reacting:
(i) Compound 1 and Compound 2;
(ii) Compound 1 and Compound 3; or
(iii) Compound 2 and Compound 3 with Compound 1;
to prepare an oligomer having silica or a complex of silica and a metal oxide present inside thereof and functional organic groups present outside thereof; and
thermal curing or photo-curing a multiplicity of the oligomers using the oligomer and functional organic groups thereof to obtain an inorganic/organic nano hybrid polymer;
wherein Compound 1 is R¹R²Si(OH)₂, Compound 2 is (R³)ₐ(R⁴)_{b}M(OR⁵)_{(c-a-b)}, and Compound 3 is R⁶OH or R⁶COOH;
R¹, R², R³, and R⁴ are independently a linear, branched, or cyclic C₁-C₁₂ hydrocarbon or fluorocarbon wherein one or more carbons are replaced with one or more linkages selected from ester, ether, or amine linkages, and/or wherein the C₁-C₁₂ hydrocarbon or fluorocarbon is substituted with one or more alkyl, ketone, acryl, methacryl, allyl, aromatic, halogen, mercapto, alkoxy, sulfonyl, nitro, hydroxyl, cyclobutenyl, carbonyl, carboxyl, urethane, vinyl, cyano, hydrogen, or epoxy;
a and b are each an integer between 0 and 3;
c is an integer between 3 and 6;
M is silicon or a metal;
R⁵ is a linear, branched, or cyclic C₁-C₁₂ hydrocarbon substituted with one or more alkyl, alkoxy, ketone, or, aromatic groups;
R⁶ is a linear, branched, or cyclic C₁-C₁₂ hydrocarbon or fluorocarbon wherein one or more carbons are replaced with one or more linkages selected from ester, ether, amide, imide, or amine linkages, and/or wherein the C₁-C₁₂ hydrocarbon or fluorocarbon is substituted with one or more alkyl, ketone, acryl, allyl, aromatic, halogen, cyano, mercapto, or epoxy;
provided that in the case of (i), at least one of R¹, R², R³, and R⁴ has a polymerizable functional group; in the case of (ii), at least one of R¹, R², and R⁶ has a polymerizable functional group; and in the case of (iii), at least one of R¹, R², R³, R⁴, and R⁶ has a polymerizable functional group.

9. A process for preparing an inorganic/organic nano hybrid polymer, comprising reacting:
(i) Compound 1 and Compound 2;
(ii) Compound 1 and Compound 3; or
(iii) Compound 2 and Compound 3 with Compound 1, to prepare an oligomer having silica or a complex of silica and a metal oxide present inside thereof and functional organic groups present outside thereof; and
thermal curing or photo-curing the oligomer and an additional organic monomer or oligomer having functional groups polymerizable with the functional organic groups of the oligomer to obtain an inorganic/organic nano hybrid polymer;
wherein Compound 1 is R¹R²Si(OH)₂, Compound 2 is (R³)ₐ(R⁴)_{b}M(OR⁵)_{(c-a-b)}, and Compound 3 is R⁶OH or R⁶COOH;
R¹, R², R³, and R⁴ are independently a linear, branched, or cyclic C₁-C₁₂ hydrocarbon or fluorocarbon wherein one or more carbons are replaced by one or more linkages selected from ester, ether, or amine linkages, and/or wherein the C₁-C₁₂ hydrocarbon or fluorocarbon is substituted with one or more alkyl, ketone, acryl, methacryl, allyl, aromatic, halogen, mercapto, alkoxy, sulfonyl, nitro, hydroxyl, cyclobutenyl, carbonyl, carboxyl, urethane, vinyl, cyano, hydrogen or epoxy;
a and b are each an integer between 0 and 3;
c is an integer between 3 and 6;
M is silicon or a metal;
R⁵ is a linear, branched, or cyclic C₁-C₁₂ hydrocarbon substituted with one or more alkyl, alkoxy, ketone, or aromatic groups;
R⁶ is a linear, branched, or cyclic C₁-C₁₂ hydrocarbon or fluorocarbon wherein one or more carbons are replaced with one or more linkages selected from ester, ether, amide, imide, or amine linkages, and/or wherein the C₁-C₁₂ hydrocarbon or fluorocarbon is substituted with one or more alkyl, ketone, acryl, allyl, aromatic, halogen, cyano, mercapto, or epoxy;
provided that in the case of (i), at least one of R¹, R², R³, and R⁴ has a polymerizable functional group; in the case of (ii), at least one of R¹, R², and R⁶ has a polymerizable functional group; and in the case of (iii), at least one of R¹, R², R³, R⁴, and R⁶ has a polymerizable functional group.

10. The method as set forth in claim 8, further comprising:
adding a metal oxide sol to reactants after preparing the inorganic/organic nano hybrid oligomer.

11. The method as set forth in claim 9, further comprising:
adding a metal oxide sol to reactants after preparing the inorganic/organic nano hybrid oligomer.

12. The method as set forth in claim 8, further comprising:
adding an appropriate amount of a dye, pigment and surfactant to control transparency and applicability after preparing the inorganic/organic nano hybrid oligomer.

13. The method as set forth in claim 9 further comprising:
adding an appropriate amount of a dye, pigment, and surfactant to control transparency and applicability after preparing the inorganic/organic nano hybrid oligomer.

14. An optical device prepared using the inorganic/organic nano hybrid polymer of claim 5.

15. An optical device prepared using the inorganic/organic nano hybrid polymer of claim 6.

16. A display comprising a dielectric, an insulator, barrier rib or protective layer comprising the inorganic/organic nano hybrid polymer of claim 5.

17. A display comprising a dielectric, an insulator, barrier rib or protective layer comprising the inorganic/organic nano hybrid polymer of claim 6.
